(19) United States
(12) Patent Application Publication
(10) Pub. No.: US 2005/0278182 A1
(43) Pub. Date: Dec. 15, 2005

(54) Submarket analyst

(76) Inventor: Paul Joseph McMahon, Tualatin, OR (US)

Correspondence Address: Paul McMahon, 8495 SW Dakota Drive, Tualatin, OR, 97062, US

(21) Appl. No.: 10/800,939

(22) Filed: Jun. 15, 2004

(51) Int. Cl. G06F 17/60

(52) U.S. Cl. 705/1

(57) ABSTRACT

This invention consists of a process of compiling income statistics (per capita income) from census data, classifying that data into nine (9) distinct classes, and applying a Natural Breaks statistical methodology to those classified statistics. The result of this composition of statistics is then graphically represented on a map as a layer located just underneath the roads and other map features, using a graduated color scale that depicts the nine respective income classes, and labels them as follows: A+, A, A−, B+, B, B−, C+, C, and C−. The highest income area is ranked “A+”, with the lowest income area ranked “C−”. This composition of matter is achieved by using a Geographical Information System (GIS). This methodology allows this location quality identification to occur quickly, as the resulting composition of matter can then be transmitted over the Internet to distant places.

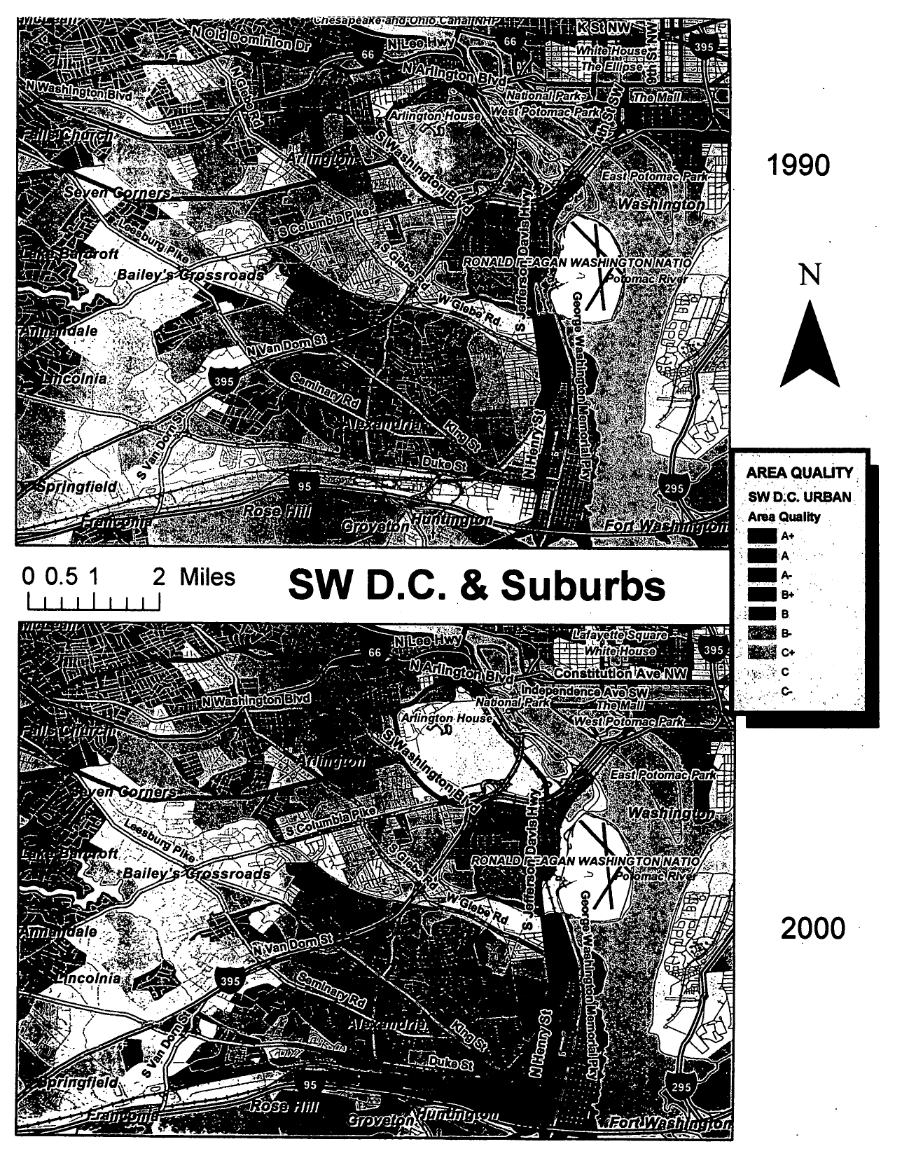

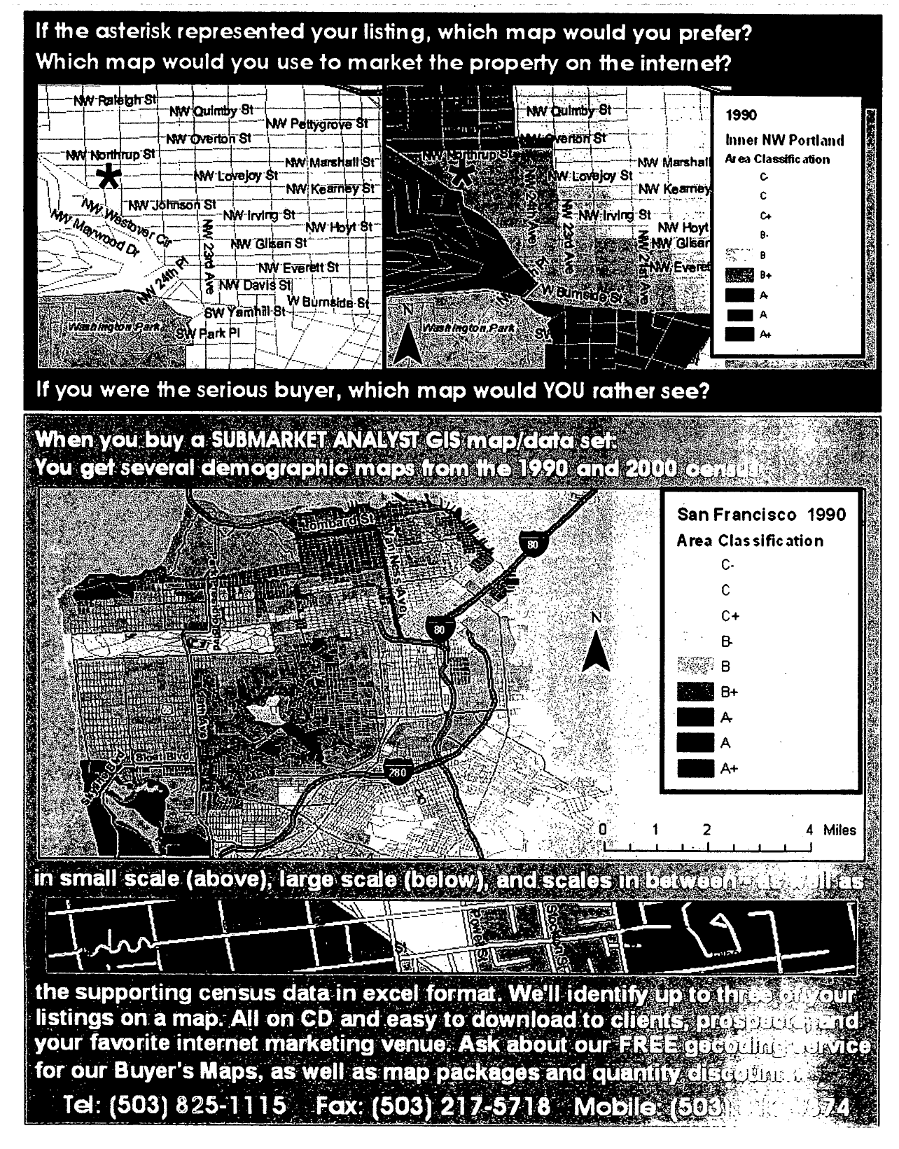

### THE INVENTION

The invention is the creation of a universally recognized definitive method of categorizing and graphically representing the economic attributes of areas and sub-areas (districts and neighborhoods) using digital demographic maps with a standardized classification system that allows the user to identify the quality of a neighborhood/area without having to actually physically visit it, thus providing a definitive method for evaluating neighborhoods from a remote location. This standardization and methodology results in easy-to-use (and transmit) thematic maps that allow the user to accurately compare neighborhoods anywhere in the United States, and understand the results, especially as they relate to neighborhoods that the user is familiar with. I call this invention “Submarket Analyst”.

### THE PROBLEM BEING SOLVED

The problem that exists today (primarily in the real estate industry) is that while there is concise information available about buildings and homes for sale, there is little or no universally recognized method available for evaluating, and effectively communicating the economic attributes of the neighborhood or vicinity that those structures occupy. The out of area prospective buyer can learn about the structure, but has no easily understood device or method that will determine the quality of the immediate and surrounding areas—the ever-important real estate component—the location.

This lack of familiarity with a remote neighborhood's quality is the reason why most out-of-area buyers (and their agents) are reluctant to make a serious offer to buy a distant property. While they usually have much information on the structure, itself, out-of-area buyers usually do not know anything pertinent about the neighborhood. More important, they have no means with which to compare a distant neighborhood's quality to one with which they are familiar with. The cost (in time and money) to travel to a remote area that might be unsuitable is simply too much. Most serious investors have made such trips, and as a result, are reluctant to pursue out-of-area properties. They simply give up.

### THE BEST MODE OF THE INVENTION

To create a universally recognized and transmittable neighborhood classification system, one must first display U.S. Census demographic data in map form vis-à-vis a demographic (thematic) map. This combination of maps and data is known as a GIS (Geographic Information System). The key census data category used in this process (that best denotes an area's overall quality) is “Per Capita Income”. The data (and related map features) should be classified based on Natural Breaks (Jenks) statistical classification method into the following nine specific categories, or grades:
A+ (extremely wealthy)
A (wealthy)
A− (somewhat wealthy)
B+ (upper middle class)
B (solid middle class)
B− (lower middle class)
C+ (lower income—slightly)
C (lower income—moderate)
C− (lower income—substantially)

This classification method shall be portrayed on the thematic map as different hues of a common color (in the attached map example, for example, the more affluent areas are darker hues of the color scheme, while the lower income areas are lighter hues of the color scheme). By using a map key (legend), the user can quickly identify an area's quality. Using this method, one can determine the quality of any neighborhood in any U.S. city (see specimen showing San Francisco and the N.W. section of Portland, Oreg.). One can also use this method with two different census years (example: 1990 and 2000) to track an area's economic movement (see Alexandria, Va. map). Because these digital maps can be electronically transmitted and printed, they are especially useful for out-of-area buyers and sellers.

### USEFUL, CONCRETE, AND TANGIBLE RESULTS STEMMING FROM THE PRACTICAL APPLICATION OF THIS INVENTION

Now, (unlike before this invention) real estate agents and their clients and prospects using a SUBMARKET ANALYST method can identify neighborhood quality on a map, definitively identify the quality of a property's location, and transmit that map to a client or prospective client. This use of such a universally recognized standard classification system with a digital thematic map will result in the following:
1. Agents with properties in good, or emerging areas will have increased inquiries, and most likely—quicker and higher profit sales.
2. Agents will not be barraged with a large number of callers inquiring about area.
3. Agents will have a larger buying audience, as out-of-area buyers can now be more certain about location quality, and are more likely to make an offer.
4. Buyers can buy with a greater degree of certainty about their investment.
5. Potential buyers looking seriously at out-of-area properties will not have to make any trips just to find out that the area was not what it was said to be.

### BEST KNOWN PRIOR ART RELATED TO INVENTION

While the commercial real estate industry has often (but not always) referred to neighborhoods as either “A”, “B”, or “C”, that reference has never been definitively quantified into a detailed, defined, and universally recognizable paradigm that would allow for accurate graphic geographic representation of ever important attributes (such as economics and certain other demographic issues) onto a map that can be quickly understood and distributed. I have checked computer search engines, CCIM (the world's largest commercial real estate brokerage network), USPTO's search engine, and the larger real estate Internet venues, including Loopnet.—And have found nothing. “Submarket Analyst”, is the first definitive area-quality determination paradigm with an effective mapping and distribution system for real estate, and the first to use a well-structured area classification scheme (Grades A+ through C−) that realtors understand. This new method of doing business will take the guesswork out of the very important factor in real estate—the quality (past and present) of a remote property's location.

Paul McMahon, Inventor (503) 692-8534 President, Map Advantage, Inc.

1. What I claim as my invention is the creation of a universally recognized method of identifying real estate location quality (through specific statistical classification, methodology, and the resulting graphical representation of income demographics using a GIS) as that of my own. I, Paul McMahon, have never seen this or any such real estate location quality identification method that can be universally recognized and graphically represented on a map—prior to this invention by myself.
